(19) United States
(12) Patent Application Publication
(10) Pub. No.: US 2010/0301633 A1
(43) Pub. Date: Dec. 2, 2010

(54) Vehicular Rear Spoiler

(76) Inventor: Po-Nien Chen, Taipei (TW)

Correspondence Address: SCHMEISER OLSEN & WATTS, 18 E UNIVERSITY DRIVE, SUITE # 101, MESA, AZ, 85201, US

(21) Appl. No.: 12/472,703

(22) Filed: May 27, 2009

(51) Int. Cl. B62D 37/02

(52) U.S. Cl. 296/180.1

(57) ABSTRACT

A vehicular rear spoiler, which is integrated with the trunk lid of a vehicle, comprises an electronic display arranged on the rear side of the spoiler body and a reelable heat-insulation sun shade collected inside the spoiler body, whereby not only advertisement or messages can be presented on the electronic display, but also the heat-insulation sun shade can be extended to the front of the vehicle to protect the vehicle from sunshine, rain and snow.

### BACKGROUND OF THE INVENTION

1. Field of the Invention

The present invention relates to a vehicular rear spoiler, particularly to a rear spoiler having an electronic display and a heat-insulation sun shade.

2. Description of the Related Art

A car running at high speed compresses ambient air and generates turbulence. The turbulence decreases the stability and performance of the car, gives the driver a sensation of floating, and thus affects the confidence of the driver. One method to solve the problem is to install a rear spoiler, which can guide stream in the rear of the car to raise the downward pressure making the car tightly contact the road, whereby promotes the stability and performance of the car when it runs at high speed.

However, none of the conventional rear spoilers has been found to integrate with other useful functions so far.

### SUMMARY OF THE INVENTION

The primary objective of the present invention is to promote the utility of a vehicular rear spoiler and integrate a vehicular rear spoiler with other useful functions.

Thus, the present invention proposes a vehicular rear spoiler having an electronic display and a reelable heat-insulation sun shade.

The vehicular rear spoiler of the present invention comprises a spoiler body having an accommodation space integrating with a spoiler frame, an electronic display arranged on the rear of the spoiler body; a reel pivotally installed on the spoiler frame; a heat-insulation sun shade having a movable side with a draw bar pulled by a force to reel out the heat-insulation sun shade; and at least one restorer spring arranged on the ends of the reel and reeling up the heat-insulation sun shade on the reel when the draw bar is not pulled by a force.

Via the abovementioned structures of the present invention, not only advertisement or messages can be shown on the electronic display, but also the heat-insulation sun shade, which is collected inside the spoiler body, can be extended to the front of the vehicle to protect the vehicle from sunshine, rain and snow.

### BRIEF DESCRIPTION OF THE DRAWINGS

FIG. 1 is a perspective exploded view of a vehicular rear spoiler according to the present invention;

FIG. 2 is a perspective view of an assembled vehicular rear spoiler according to the present invention; and

FIG. 3 is a diagram schematically showing that a vehicular rear spoiler according to the present invention is installed on the trunk lid of a vehicle.

### DETAILED DESCRIPTION OF THE INVENTION

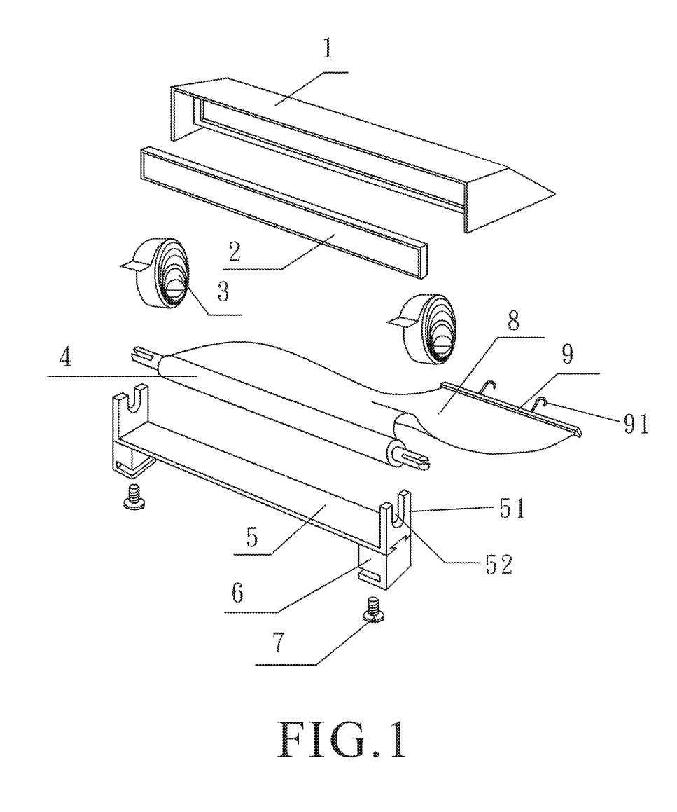

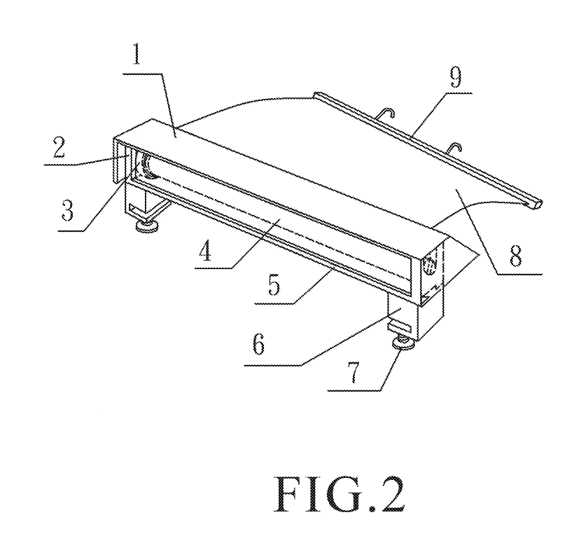

Referring to FIG. 1 and FIG. 2, the present invention discloses a vehicular rear spoiler having an electronic display and a reelable heat-insulation sun shade, which comprises a spoiler body 1, an electronic display 2, at least one restorer spring 3, a reel 4, a spoiler frame 5, two fixing seats 6, fixing screws 7, a heat-insulation sun shade 8 and a draw bar 9.

The electronic display 2 is arranged on the rear side of the spoiler body 1 and used to present messages or advertisement to the drivers behind the vehicle. The electronic display 2 is one of displays existing currently, including the LED display and the liquid crystal display.

The spoiler body 1 has an accommodation space integrating with the spoiler frame 5. Two ends of the spoiler frame 5 respectively have supporters 51 extending upward. The two supporters 51 respectively have notches 52 where two ends of the reel 4 are pivotally installed.

The heat-insulation sun shade 8 is reeled up on the reel 4. The heat-insulation sun shade 8 has a movable side integrating with a draw bar 9. When a force pulls the draw bar 9, the heat-insulation sun shade 8 is reeled out. The draw bar 9 has at least one hook 91 to hook on to rings or other appropriate objects on the vehicle.

Two ends of the reel 4 have at least one restorer spring 3. When the draw bar 9 is not pulled by a force, the restorer spring 3 keeps or restores the reel-up status of the heat-insulation sun shade 8. Thus, the heat-insulation sun shade 8 is collected inside the spoiler body 1.

The fixing seats 6 are integrated with the bottom of the spoiler frame 5. The fixing seats 6 are stuck to the trunk lid of the vehicle with adhesive or fastened to the trunk lid of the vehicle with fixing screws 7. Thereby, the spoiler frame 5 is firmly fixed onto the trunk lid of the vehicle.

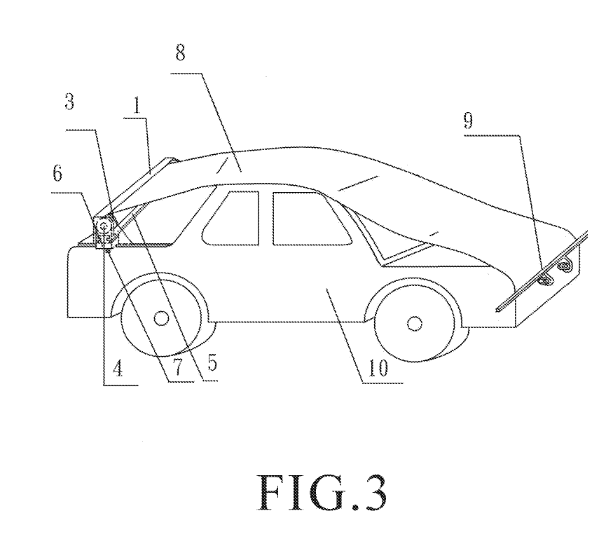

Referring to FIG. 3, a diagram schematically shows that the vehicular rear spoiler of the present invention is installed on the trunk lid of a vehicle 10. The present invention integrates an electronic display 2 and a reelable heat-insulation sun shade 8 with a spoiler. Therefore, the present invention provides addition functions for drivers in addition to the function of a spoiler.

In conclusion, the present invention proposes a vehicular rear spoiler having an electronic display 2 and a reelable heat-insulation sun shade 8, whereby not only advertisement or messages can be shown on the electronic display 2, but also the heat-insulation sun shade 8, which is collected inside the spoiler body 1, can be extended and fixed to the front of the vehicle to protect the vehicle from sunshine, rain and snow.

What is claimed is:

1. A vehicular rear spoiler comprises
a spoiler body having an accommodation space integrating with a spoiler frame;
an electronic display arranged on a rear side of said spoiler body;
a reel pivotally installed on said spoiler frame;
a heat-insulation sun shade having a movable side with a draw bar pulled by a force to reel out said heat-insulation sun shade; and
at least one restorer spring arranged on ends of said reel and reeling up said heat-insulation sun shade on said reel when said draw bar is not pulled by a force.

2. The vehicular rear spoiler according to claim 1, wherein said draw bar has at least one hook.

3. The vehicular rear spoiler according to claim 1, wherein said spoiler frame are integrated with fixing seats.

4. The vehicular rear spoiler according to claim 3, wherein said fixing seats are integrated with a trunk lid of a vehicle.

5. The vehicular rear spoiler according to claim 4, wherein said fixing seats are fastened to a trunk lid of a vehicle with screws.
